(19) United States
(12) Patent Application Publication
(10) Pub. No.: US 2014/0358348 A1
(43) Pub. Date: Dec. 4, 2014

(54) ELECTRIC VEHICLE AND METHOD FOR CONTROLLING SAME

(71) Applicant: Sung Chul Park, Incheon (KR)

(72) Inventor: Sung Chul Park, Incheon (KR)

(73) Assignee: LG ELECTRONICS INC., Seoul (KR)

(21) Appl. No.: 14/365,836

(22) PCT Filed: Dec. 14, 2012
(86) PCT No.: PCT/KR2012/010955

§ 371 Date: Jun. 16, 2014

(30) Foreign Application Priority Data
Dec. 16, 2011 (KR) 10-2011-0136499

(51) Int. Cl. B60L 15/20

(52) U.S. Cl. CPC B60L 15/20; Y10S 903/903
USPC 701/22; 180/65.285; 903/903

(57) ABSTRACT

The present invention relates to an electric vehicle and to a method for controlling same. The electric vehicle according to the present invention comprises: a sensor unit including a first sensor and a second sensor; and a vehicle control unit including a main processing unit and a sub-processing unit for taking, as an input, signals from the sensor unit and performing an operation. The main processing unit takes, as an input, a first sensor value measured by the first sensor and a second sensor value measured by the second sensor, and compares the first sensor value and the second sensor value so as to obtain a first difference value. The sub-processing unit takes, as an input, a second difference value obtained from the difference between the first sensor value and the second sensor value. The main processing unit or the sub-processing unit compares the first difference value and the second difference value in order to determine the state of the vehicle and control the travel of the vehicle.

### TECHNICAL FIELD

Embodiments of the present invention relates to an electric vehicle and a method of controlling the same, and more particularly, to an electric vehicle including a plurality of sensors and a plurality of processors and comparing a difference between values measured by the plural sensors with a processed value in terms of hardware and a processed value in terms of software to control vehicle driving, and a method of controlling the electric vehicle.

### BACKGROUND ART

Research has been actively conducted into electric vehicles in terms of alternatives that are most likely to address conventional vehicle pollution and energy problems.

An electric vehicle (EV) is a vehicle that drives an alternating current (AC) or direct current (DC) motor using battery power to obtain power and is largely classified into a battery powered electric vehicle and a hybrid electric vehicle. The battery powered electric vehicle drives a motor using battery power and is charged when battery power is entirely consumed. The hybrid electric vehicle is moved by driving an engine to generate electricity and to charge a battery and driving an electric motor using the electricity.

The hybrid electric vehicle may be classified into a series-type hybrid electric vehicle and a parallel-type hybrid electric vehicle. The series-type hybrid electric vehicle is always driven by a motor by converting mechanical energy output from an engine into electrical energy via a generator and supplying the electrical energy into a battery or the motor and is interpreted as the concept obtained by adding an engine and a generator to a conventional electric vehicle for improvement in mileage. The parallel-type hybrid electric vehicle uses two power sources for moving the vehicle via only battery power or only an engine (gasoline or diesel) and is driven using both the engine and the motor according to a driving condition.

Recently, motor/control technology has been gradually developed and high power of small systems with high efficiency has been developed. As a DC motor is converted into an AC motor, power performance (acceleration performance and high speed) of electric vehicles is remarkably increased. Accordingly, electric vehicles have reached a level equivalent to gasoline vehicles. As a motor of high power and high rate of rotation have been achieved, the motor has become lightweight and small and has been reduced in weight on board or volume.

The electric vehicle includes a plurality of sensors and is configured to input values, obtained by multiply measuring with respect to the same information, to a main processor and to compare and process a plurality of inputs so as to reinforce the stability of the electric vehicle. In addition, the electric vehicle includes a separate subprocessor in addition to the main processor, and the main processor and the subprocessor monitor each other to check whether a system operates normally. Thus, values measured by a plurality of sensors need to be input to the subprocessor.

In this case, when an input line of a sensor is branched in order to input a measured value to the subprocessor, drop in input voltage occurs. In addition, when values measured by a plurality of sensors are input to the main processor or the subprocessor and values input to the main processor or the subprocessor are transceived and processed, time delay issues occur. In addition, when values measured by separate different sensors occur, problems occur in terms of increase in package size and costs.

### DISCLOSURE

### Technical Problem

It is an aspect of the present invention to provide an electric vehicle and a method of controlling the same, in which a subprocessor receives a difference value of values measured by a plurality of sensors, and a main processor or the subprocessor compares the measured value with a difference value calculated by the main processor to control vehicle driving.

### Technical Solution

In accordance with one aspect of the present invention, an electric vehicle includes a sensor unit including a first sensor and a second sensor, and a vehicle control module including a main processor and a subprocessor, for receiving signals from the sensor unit and performing calculation, wherein the main processor receives a first sensor value measured by the first sensor and a second sensor value measured by the second sensor and compares the first sensor value and the second sensor value to calculate a first difference value, the subprocessor receives a second difference value obtained by measuring a difference value between the first sensor value and the second sensor value, and the main processor or the subprocessor compares the first difference value and the second difference value to determine a vehicle status and controls driving.

In accordance with another aspect of the present invention, a method of controlling an electric vehicle includes inputting a first sensor value, a second sensor value, and a second difference value obtained by measuring a difference value between the first sensor value and the second sensor value, comparing the difference value between the first sensor value and the second sensor value to calculate a first difference value, and comparing the first difference value and the second difference value to determine a vehicle status and controlling driving.

### Advantageous Effects

In an electric vehicle and a method of controlling the same, a subprocessor may receive a difference value between values measured by a plurality of sensors in terms of hardware.

A difference value calculated by a main processor in terms of software and a difference value received by the subprocessor in terms of hardware are compared with each other to control vehicle driving.

A separate sensor is not used, thereby simplifying a package and lowering costs.

Accordingly, the economic feasibility, stability, and reliability of an electric vehicle may be enhanced.

### DESCRIPTION OF DRAWINGS

FIG. 1 is a schematic diagram illustrating an internal structure of an electric vehicle according to an embodiment of the present invention.

FIG. 2 is a diagram illustrating a signal input system between a sensor unit and a vehicle control module (VCM) of an electric vehicle according to an embodiment of the present invention.

FIG. 3 is a flowchart of a method of controlling an electric vehicle according to an embodiment of the present invention.

### MODE FOR INVENTION

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements.

Hereinafter, an electric vehicle and a method of controlling the same according to embodiments of the present invention will be described with reference to the attached drawings.

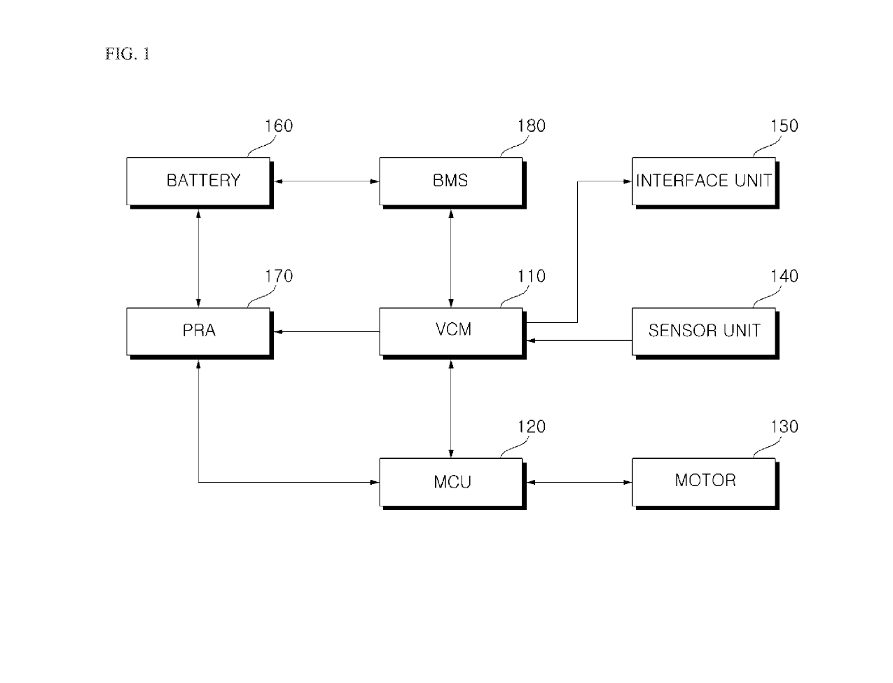

FIG. 1 is a schematic diagram illustrating an internal structure of an electric vehicle according to an embodiment of the present invention.

Referring to FIG. 1, the electric vehicle according to an embodiment of the present invention includes a vehicle control module (VCM) 110, a motor control unit (MCU) 120, a motor 130, a sensor unit 140, an interface unit 150, a battery 160, a power relay assembly (PRA) 170, and a battery management system (BMS) 180.

The electric vehicle includes the battery 160, operates using power stored in the battery 160, and charges the battery 160 included in the electric vehicle, which receives power from an external source such as a predetermined charging station, vehicle charging equipment, or the home.

The battery 160 includes a plurality of battery cells and stores high voltage electric energy. In this case, the electric vehicle further includes the BMS 180 that controls charging of the battery 160, determines residual capacity and the need to charge the battery 160, and performs management for supply of charged current stored in the battery 160 to each unit of the electric vehicle.

During charging and use of the battery 160, the BMS 180 controls the battery 160 such that a voltage difference between cells in the battery 160 is uniformly maintained and the battery 160 is not overcharged or over discharged, thereby extending lifetime of the battery 160.

The BMS 180 measures current battery residual capacity and battery voltage of the battery 160 and outputs information about the current battery residual capacity and battery voltage to the VCM 110.

The PRA 170 includes a sensor and a plurality of relays for high voltage switching and supplies or interrupts high voltage of operating power supplied from the battery 160 to or from the MCU 120. In this case, relays of the PRA 170 operate according to a control command of the VCM 110.

When an engine of the electric vehicle is turned on or turned off, the PRA 170 switches a plurality of relays included in the electric vehicle in a predetermined order according to the control command of the VCM 110 so as to supply high voltage of operating power stored in the battery 160 to each unit of the electric vehicle.

The PRA 170 may interrupt power supplied to the MCU 120 from the battery 160 to interrupt power supplied to the motor 130. Accordingly, the motor 130 is stopped and thus the electric vehicle is also stopped.

The MCU 120 generates a control signal for driving at least one motor 130 connected to the MCU 120 and generates a predetermined signal for motor control and supplies the signal to the motor 130. In this case, the MCU 120 may include an inverter (not shown) and a converter (not shown) and control the inverter or the converter to control driving of the motor 130.

The VCM 110 controls an overall operation for vehicle driving and operation. The VCM 110 generates and supplies a predetermined command to the MCU 120, controls the MCU 120 to perform a set operation corresponding to input of the sensor unit 140, and controls data input and output.

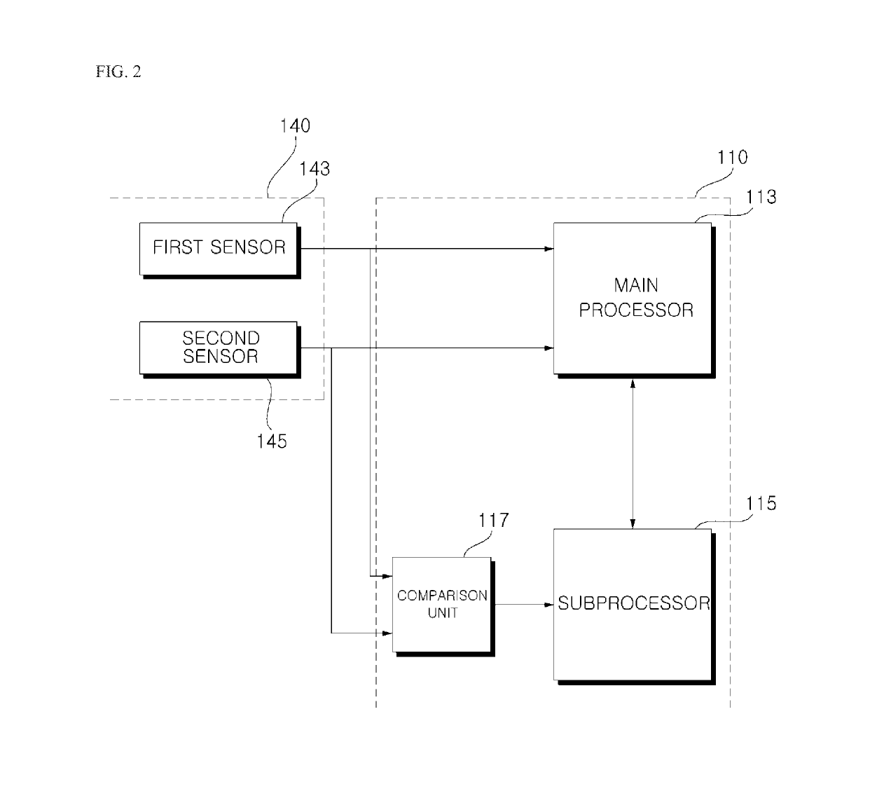

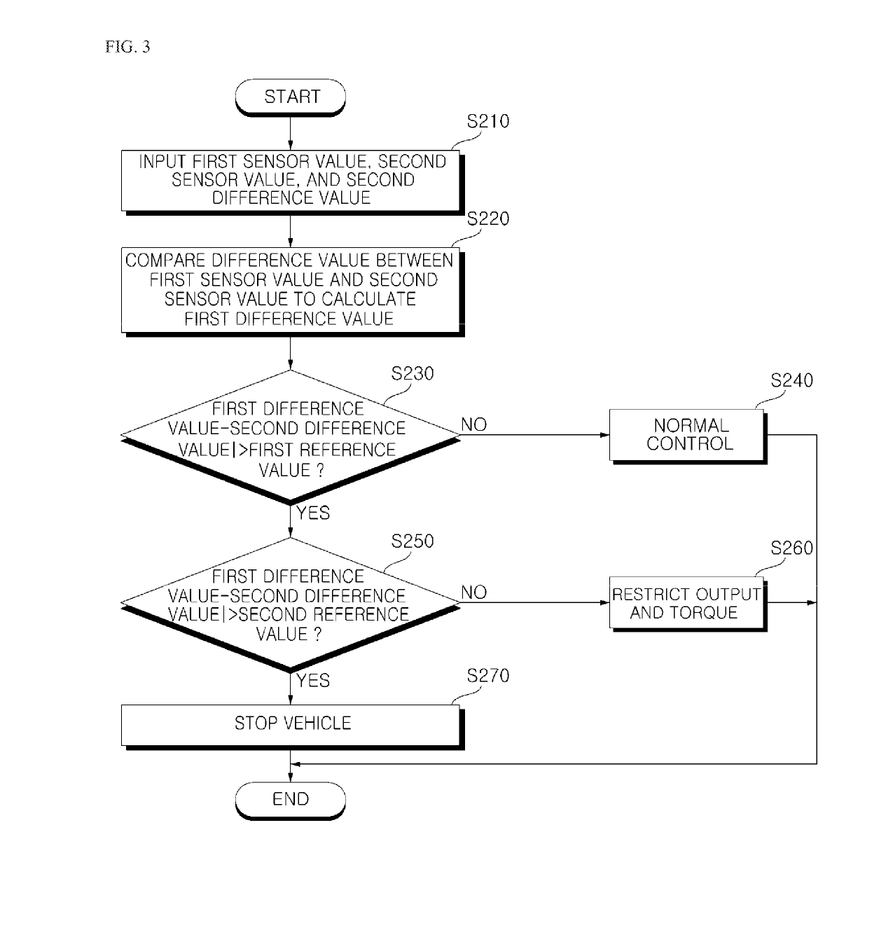

In addition, the VCM 110 may include a plurality of processors that monitor each other to periodically transmit and receive status information and to determine whether a system is currently normal. The plural processors receive and process signals input from the sensor unit 140, which will be described in detail with reference to FIGS. 2 and 3.

The sensor unit 140 detects signals generated during vehicle driving or predetermined operations and inputs the signals to the VCM 110. The sensor unit 140 includes a plurality of sensors installed inside and outside the electric vehicle. In this case, types of the sensors may also differ according to installment position.

The sensor unit 140 may include a gear shift sensor, an accelerator position sensor (APS), a break position sensor (BPS), a speed sensor, etc. The gear shift sensor indicates a gear shift status, the APS indicates an acceleration status, and the BPS indicates a degree to which a driver puts on a brake. In addition, the speed sensor measures vehicle speed. The sensor unit 140 includes the aforementioned plural sensors that multiply measure the same information, thereby ensuring reliability of measured values.

The interface unit 150 includes an input unit for inputting a predetermined signal via driver manipulation and an output unit for externally outputting information during current status operation of the electric vehicle.

The input unit may be a manipulation unit for driving, such as a steering wheel, an accelerator, and a brake. The accelerator outputs acceleration information for calculation of torque, and the brake outputs brake information for calculation of torque.

In addition, the input unit includes a plurality of switches, a button, etc. for operations of a turn signal lamp, a tail lamp, a head lamp, a brush, etc. according to vehicle driving.

The output unit includes a display for displaying information, a speaker for outputting music, sound effects, and warning sounds, and units for outputting various statuses, etc. Accordingly, when the main processor or the subprocessor malfunctions, whether the electric vehicle is abnormal may be displayed to the driver through the output unit.

FIG. 2 is a diagram illustrating a signal input system between the sensor unit 140 and the VCM 110 of an electric vehicle according to an embodiment of the present invention.

Referring to FIG. 2, the VCM 110 may include a main processor 113 and a subprocessor 115, and the sensor unit 140 may include a first sensor 143 and a second sensor 145.

The first sensor 143 and the second sensor 145 may measure the same information and may be, for example, a gear shift sensor, an accelerator position sensor (APS), a break position sensor (BPS), or a speed sensor. As described above, the electric vehicle includes a plurality of sensors for measurement of the same information, thereby ensuring reliability of measured values.

The main processor 113 may receive a first sensor value and a second sensor value that are measured by the first sensor 143 and the second sensor 145, respectively and compare the first sensor value and the second sensor to calculate a difference value (hereinafter, referred to as a “first difference value”).

A comparison unit 117 may output a difference value (hereinafter, referred to as a “second difference value” between the first sensor value and the second sensor value using a comparator, etc.

The subprocessor 115 may receive the second difference value from the comparison unit 117.

The main processor 113 or the subprocessor 115 compares the first difference value and the second difference value to calculate a difference value between the first difference value and the second difference value and compares the difference value between the first difference value and the second difference value with a predetermined first reference value and a predetermined second reference value.

The VCM 110 controls vehicle driving according to the comparison result. For example, when the difference value between the first difference value and the second difference value is equal to or less than the first reference value, the VCM 110 may allow normal driving without limitation of motor output and torque.

On the other hand, when the difference value between the first difference value and the second difference value is greater than the first reference value, the VCM 110 sets restriction of motor output and torque, and allows driving within the restriction.

In addition, when the difference value between the first difference value and the second difference value is greater than the second reference value that is set to be greater than the first reference value, the VCM 110 controls the electric vehicle to stop.

FIG. 3 is a flowchart of a method of controlling an electric vehicle according to an embodiment of the present invention.

Referring to FIG. 3, the first sensor 143 and the second sensor 145 input a first sensor value measured by the first sensor 143 and a second sensor value measured by the second sensor 145 to the main processor 113 and the comparison unit 117 (S210). In this case, the comparison unit 117 outputs a difference value between the first sensor value and the second sensor value as a second difference value and inputs the second difference value to the subprocessor 115.

The main processor 113 compares the received first sensor value and second sensor to calculate a first difference value (S220).

The main processor 113 or the subprocessor 115 determines whether a difference value between the first difference value and the second difference value is greater than a predetermined first reference value (S230).

When the difference value between the first difference value and the second difference value is not greater than the first reference value, the VCM 110 determines that the main processor 113 is normal and allows normal driving without limitation of motor output and torque (S240).

When the difference value between the first difference value and the second difference value is greater than the first reference value, the main processor 113 or the subprocessor 115 determines whether the difference value between the first difference value and the second difference value is greater than the second reference value that is set to be greater than the first reference value (S250).

As a result of the determination, when the difference between the first difference value and the second difference value is not greater than the second reference value, the electric vehicle does not stop, and the VCM 110 sets restriction of motor output and torque, and allows driving within the restriction (S260).

When the difference between the first difference value and the second difference value is greater than the second reference value, the VCM 110 issues a stop command to the MCU 120 and controls a motor to interrupt power supplied to the MCU 120 from the battery 160 (S270).

Accordingly, according to an electric vehicle and a method of controlling the same according to the embodiments of the present invention, a vehicle control module includes a main processor and a subprocessor, the main processor receives sensor values of the main processor and the subprocessor to calculate a difference value between the sensor values (result of process in terms of software), the subprocessor receives the difference value of the sensors (result of process in terms of hardware), and the main processor or the subprocessor compare the two values so as to control vehicle driving. Accordingly, signal processing reliability may be enhanced and stability may be enhanced.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. An electric vehicle comprising:
a sensor unit comprising a first sensor and a second sensor; and
a vehicle control module comprising a main processor and a subprocessor, for receiving signals from the sensor unit and performing calculation,
wherein:
the main processor receives a first sensor value measured by the first sensor and a second sensor value measured by the second sensor and compares the first sensor value and the second sensor value to calculate a first difference value;
the subprocessor receives a second difference value obtained by measuring a difference value between the first sensor value and the second sensor value; and
the main processor or the subprocessor compares the first difference value and the second difference value to determine a vehicle status and controls driving.

2. The electric vehicle according to claim 1, wherein the vehicle control module sets a restriction of motor output and torque and controls the electric vehicle to operate within the restriction when the difference value between the first difference value and the second difference value is greater than a predetermined first reference value.

3. The electric vehicle according to claim 2, wherein the vehicle control module controls the vehicle to stop when the difference value between the first difference value and the second difference value is greater than a second reference value set to be greater than the first reference value.

4. The electric vehicle according to claim 1, further comprising an interface unit for externally displaying a status of the vehicle,
wherein the interface unit displays abnormality of the vehicle when the difference value between the first difference value and the second difference value is greater than the first reference value.

5. The electric vehicle according to claim 1, wherein the first sensor and the second sensor is at least one of a gear shift sensor, an accelerator position sensor (APS), a break position sensor (BPS), and a speed sensor.

6. A method of controlling an electric vehicle, the method comprising:
inputting a first sensor value, a second sensor value, and a second difference value obtained by measuring a difference value between the first sensor value and the second sensor value;
comparing the difference value between the first sensor value and the second sensor value to calculate a first difference value; and
comparing the first difference value and the second difference value to determine a vehicle status and controlling driving.

7. The method according to claim 6, further comprising setting a restriction of motor output and torque and controlling the electric vehicle to operate within the restriction when the difference value between the first difference value and the second difference value is greater than a predetermined first reference value, as a result of the determination.

8. The method according to claim 7, wherein the vehicle control module controls the vehicle to stop when the difference value between the first difference value and the second difference value is greater than a second reference value set to be greater than the first reference value, as a result of the determination.

9. The method according to claim 6, further comprising displaying abnormality of the vehicle when the difference value between the first difference value and the second difference value is greater than the first reference value, as a result of the determination.
